(19) United States
(12) Patent Application Publication
(10) Pub. No.: US 2018/0050656 A1
(43) Pub. Date: Feb. 22, 2018

(54) PORTABLE FASTENING DEVICE FOR SAFETY BELT OF CAR

(71) Applicant: Dai-Gil KIM, Gyeonggi-do (KR)

(72) Inventor: Dai-Gil KIM, Gyeonggi-do (KR)

(21) Appl. No.: 15/542,170

(22) PCT Filed: Aug. 30, 2016
(86) PCT No.: PCT/KR2016/009645

§ 371 Date: Jul. 7, 2017

(30) Foreign Application Priority Data
Jan. 19, 2016 (KR) 10-2016-0006383

(51) Int. Cl. B60R 22/02; B60R 22/20; B60R 22/26

(52) U.S. Cl. CPC B60R 22/02; B60R 22/20; B60R 2022/1812; B60R 2022/027; B60R 22/26

(57) ABSTRACT

A portable fastening device for a safety belt of a car, according to the disclosure, includes a case formed in the shape of a “V” and having opening parts respectively formed to be separate from each other in both ends of the “V”-shaped case such that the fastening clips of seat belts are inserted thereinto, one pair of fastening parts respectively provided to the inner space of a portion, which is inclined in the shape of “V” in the case, so as to be fastened to the fastening clips of the safety belts, which are inserted through the opening parts, and release parts mounted on upper end portions of the inner space of the case so as to operate such that the fastening clips of the safety belts, which are fastened to the fastening parts, are released.

### BACKGROUND

The present invention relates to a portable fastening device for a safety belt of a car and, more particularly, to a portable fastening device for a safety belt of a car, in which the fastening positions between the fastening device and the fastening clips of safety belts can be adjusted according to the physique of an occupant such that the portable fastening device for a safety belt of a car can be used comfortably, particularly, without pressing the neck portion of a child or the abdomen portion of a pregnant woman.

In order to prevent an occupant from falling out of a seat and colliding with any structure in a car, due to inertia caused by sudden stop, rear-end collision or head-on collision during driving, the car is equipped with a safety belt for each seat, and, in particular, it is mandatory to wear a safety belt on an expressway, along which a lot of traffic can move at very high speeds.

Such a safety belt is a very important means to reduce injury caused when an occupant sitting in a seat falls off the seat and hits a structure in the car in an accident.

Generally, the safety belt includes a belt, of which both ends are respectively fixed at the upper and lower portions of a seat at one side thereof, a fastening clip fitted into the belt and of which position is movable, and a buckle a fastening device fixed at the lower portion of the seat at the other side thereof so as to be detachably fastened to the fastening clip. When fastening such a safety belt, an occupant pulls the fastening clip and fastens the same into the buckle the fastening device in a state, in which the belt diagonally presses his or her shoulder and chest at the upper portion thereof and, simultaneously, comes in contact with his or her abdomen portion at the lower portion thereof.

All safety belts provided to the vehicle are attached to seats made to fit the adult body. In the case of children, when the safety belt is fastened, the crossed belt is caught on the neck of a child, causing discomfort. Further, in the case of a child with a smaller physique, there is a problem that the safety belt function cannot be properly performed because the child's head is released between the crossed belt and the seat back. Meanwhile, in the case of a pregnant woman, since the belt is fastened on the abdomen in tight contact with the abdomen, pressing the abdomen, there is a problem that the belt is unfit for use by the pregnant woman.

Therefore, in the case of children, an expensive child safety seat is used. However, such a child safety seat still has problems. First, it is inconvenient to install the child safety seat to a seat in a car. In addition, since the child safety seat restrains a child, who instinctively moves a lot, the child is reluctant to sit in the child safety seat if the child grows up a little. Besides, it is necessary to pick up and carry the bulky and heavy child safety seat whenever taking a taxi or using any other cars. In addition, there is a further problem in that there is no safety means that a child can wear without discomfort in a car, until the child, who is no longer the age to use the child safety seat, grows up enough to wear the safety belt of a car without discomfort.

With respect to the car safety belt, there have been disclosed many techniques such as Korean Patent No. 1389067 entitled “safety belt system for vehicle seat” and Korean Patent No. 1242100 entitled “safety belt with height-adjustable guard”. However, as pointed above, there is no safety belt fastening device for solving the above problems, which can replace the child safety seat, carried and used in any vehicles, used conveniently and safely for an occupant like a child, who is smaller than an adult, or a pregnant woman, who should be prevented pressure on part of her body.

### SUMMARY OF THE INVENTION

Accordingly, the present invention has been made to solve the above-mentioned problems occurring in the prior arts, and it is an objective of the present invention to provide a portable fastening device for a safety belt of a car, in which one pair of fastening parts are provided separately at both sides so as to form the fastening device into the shape of a “V” and the fastening positions between fastening clips connected to safety belts and the fastening device can be adjusted such that the portable fastening device for a safety belt of a car can be used comfortably without pressing the neck portion of a child or the abdomen portion of a pregnant woman during the wearing of the safety belts.

it is another objective of the present invention to provide a portable fastening device for a safety belt of a car, in which the fastening positions between the fastening device and the fastening clips of safety belts, which are respectively positioned at both sides of an occupant, can be adjusted such that, during the wearing of the safety belts, the belts tightly hold the both side shoulders of the occupant respectively and the fastening device is positioned on the front portion of the occupant. Therefore, it is not necessary to use a child safety seat that a child uses in a car, and the portable fastening device can be carried and used in another vehicle in the same manner.

To accomplish the above objectives, according to the present invention, there is provided a portable fastening device for a safety belt of a car, including: a case formed in the shape of a “V” and having opening parts formed to be separate from each other in both ends of the “V”-shaped case such that the fastening clips of seat belts, which are respectively positioned at both sides of a seat, are inserted thereinto; one pair of fastening parts respectively provided to the inner space of a portion, which is inclined in the shape of “V” in the case, so as to be fastened to the fastening clips of the safety belts, which are inserted through the opening parts; and release parts mounted on the upper end portions of the inner space of the case so as to operate such that the respective fastening clips of the safety belts, which are fastened to the fastening parts, are released from the fastening parts, wherein the fastening device is to be carried and fastened to each of the fastening clips of the safety belts respectively positioned at both sides of a seat in a car.

It is preferable that the fastening part includes: a fastening member capable of carrying out seesaw motion with respect to a hinge shaft, which is respectively located in the center portions of both sides in the longitudinal direction, and having a holding protrusion, which is formed on the front end thereof so as to be protruded vertically in the downward direction, and a protrusion portion, of which a rear end portion is formed to be protruded in the upward direction and a front surface is inclined in the downward direction towards the front end side; and a first spring, of which both ends are respectively mounted between the lower surface of the protrusion portion of the fastening member and the bottom surface of the case, and the release part includes: a release button, of which a front end is positioned at the upper portion of the opening part of the case and a rear end operates to press the inclined protrusion portion of the fastening member; and one pair of second springs, of which both ends are respectively mounted between the side surface of the release button and the inner surface of the upper portion of the inner space of the case.

It is preferable that the fastening part includes: a fastening member capable of carrying out seesaw motion with respect to a hinge shaft, which is respectively located in the center portions of both sides in the longitudinal direction, and having a holding protrusion, which is formed on the front end thereof so as to be protruded vertically in the downward direction; and a first spring, of which both ends are respectively mounted between the lower surface of the rear end portion of the fastening member and the bottom surface of the case, and the release part includes: a release button, of which a main body upper end is provided to be protruded to the center of the upper portion of the case and a main body lower end positioned in the inner space of the case has a pressure plate, which is formed integrally with a main body thereof and has a diameter larger than that of the main body; and one pair of second springs, of which both ends are respectively mounted between the top surface of the pressure plate of the release button and the inner surface of the upper portion of the inner space of the case so as to be provided outside the main body of the release button, wherein, if the release button is pressed, the pressure plate presses the rear ends of the fastening members of the one pair of fastening parts simultaneously such that the respective fastening states of the fastening parts and the fastening clips are simultaneously released.

According to another embodiment of the present invention, there is provided a portable fastening device for a safety belt of a car, including: one pair of cases, each of which has a fastening part and a release part; and connection plates respectively provided to the rear ends of the respective cases, wherein portions of the respective connection plates are overlapped with each other so as to be connected to each other by a connection means, or the connection plates for connecting the one pair of cases are integrally formed, such that the whole fastening device is formed in the shape of a “V”.

The portable fastening device for a safety belt of a car, according to the present invention, has a general “V” shape and includes the fastening parts, which are respectively provided at both ends thereof so as to be respectively fastened to the fastening clips connected to the safety belts, which are installed at both sides of a seat, and the positions of the fastening clips can be adjusted according to the position of the fastening device while fastening the fastening clips to the fastening device. Therefore, it is possible to fasten the fastening device at a comfortable positions according to the physique or the body condition of an occupant, particularly a child, who is physically smaller than an adult, or a pregnant woman, who should be prevented pressure on abdomen of her body. Accordingly, even a child or a pregnant woman can fasten the safety belts at comfortable positions, without any discomfort due to the safety belt fastening, in a car.

Besides, as for the portable fastening device for a safety belt of a car, according to the present invention, the fastening clips of the safety belts are fastened to the fastening device at both sides thereof, the belts respectively positioned at both sides of a seat respectively hold the both side shoulders of an occupant, and the fastening device is positioned on the front portion of the occupant while connecting the both side belts. Therefore, it is possible to minimize the sense of restraint on the movement of a child when the child feels in a child safety seat, and there is no need to use a high-priced child safety seat. Also, since the fastening device is not fixedly attached to a car but is separated from the car when the fastening device is not fastened, the fastening device can be carried by a guardian of a child or a user and then used in any other car as it is. Therefore, it is not necessary to carry a bulky and heavy child safety seat hard and install the same with difficulty.

In addition, the portable fastening device for a safety belt of a car, according to the present invention, can be used as it is without the necessity of installing any additional device in the existing passenger car or changing the structure of the safety belt. Even when a normal adult uses the portable fastening device according to the present invention, while the fastening clips are fastened to the fastening device, the belts respectively positioned at both sides of a seat respectively hold the both side shoulders of an occupant and the fastening device is positioned on the front portion of the occupant while connecting the both side belts. Therefore, even if an accident occurs during driving, the risk of injury to the occupant can be significantly reduced.

### BRIEF DESCRIPTION OF DRAWINGS

FIG. 1 is a view for showing a state, in which a portable fastening device according to the present invention is fastened.

FIG. 2 is a view for showing a state, in which a fastening clip is fastened to and the other fastening clip is released from the fastening device.

FIG. 3 is a cross-sectional view of the fastening device.

FIGS. 4a to 4d are cross-sectional views for explaining the fastening and releasing operations of the fastening device.

FIG. 5 is a view for showing a portable fastening device according to a second embodiment of the present invention.

FIGS. 6a and 6b are cross-sectional views for explaining the fastening and releasing operations of the fastening device of FIG. 5, and

FIG. 7 is a view for showing a portable fastening device according to a third embodiment of the present invention.

### DETAILED DESCRIPTION OF THE PREFERRED EMBODIMENT

A portable fastening device for a safety belt of a car, according to the present invention, includes the most important technical features, wherein the fastening device is formed in a “V” shape and includes fastening parts, which are respectively provided at both ends thereof, so as to be respectively fastened to the fastening clips of safety belts at both sides of the fastening device such that the belts respectively hold the both side shoulders of an occupant and thus the fastening device can be used for a child, instead of a child safety seat, and wherein the fastening device is portable and thus is not mounted in a car but can be completely separated from the car when not fastened to the safety belts such that the fastening device can be carried by a child's guardian or a user and then used in any other car as it is.

The portable fastening device for a safety belt of a car, according to the present invention, since the fastening device of the present invention should have safety belts installed at both sides of an occupant, a belt installed for the middle one of the rear seats for three passengers in a passenger car should be utilized for the left or right seat. That is, a user should ride on the left or right side and use a belt installed for the original left or right seat as one side safety belt and the belt installed for the middle seat as the other side safety belt.

A safety belt fastening device 20, 20′, 20″ according to the present invention includes a case 21, 21′, 21″ formed in the shape of a “V” and fastening parts 22, 22′, 22″ branched therefrom so as to be arranged separately from each other and fastened to safety belt fastening clips 12 such that, when fastened to safety belts, the fastening device 20, 20′, 20″ are positioned in the center in the lateral direction of a user and the fastening position thereof can be randomly adjusted at a comfortable height. In this state, since the safety belt fastening clips 12 are fastened to the case 21, 21′, 21″ at both sides thereof, the belts 11 of the safety belts respectively hold the both side shoulder portions of the user and the fastening device 20, 20′, 20″ connects the both side belts. Therefore, the neck portion or the abdomen of the user is not pressed such that the user does not feel any discomfort caused by the wearing of the safety belts, and the safety belts ensure that the body of the user does not bounce off the seats in case of accident.

It is preferable that an angle between the “V” shape of the case 21, 21′, 21″ is formed to be an acute angle of about 30-60°. In this way, if opening parts 211, 211′, 211″ are formed so as to be separate from each other and to have an acute angle, it is easy to fasten the fastening clips 12 of the both sides and the belts 11 of the safety belts are not twisted. If the opening parts 211, 211′, 211″ are formed in the vertical direction, fastening clips 12 cannot be fastened and the belts 11 are twisted so that the safety belts 10 cannot function.

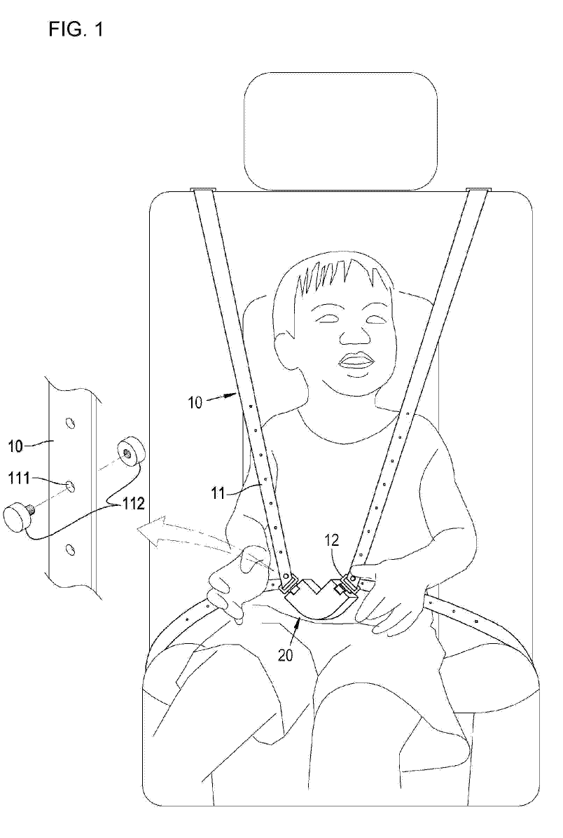

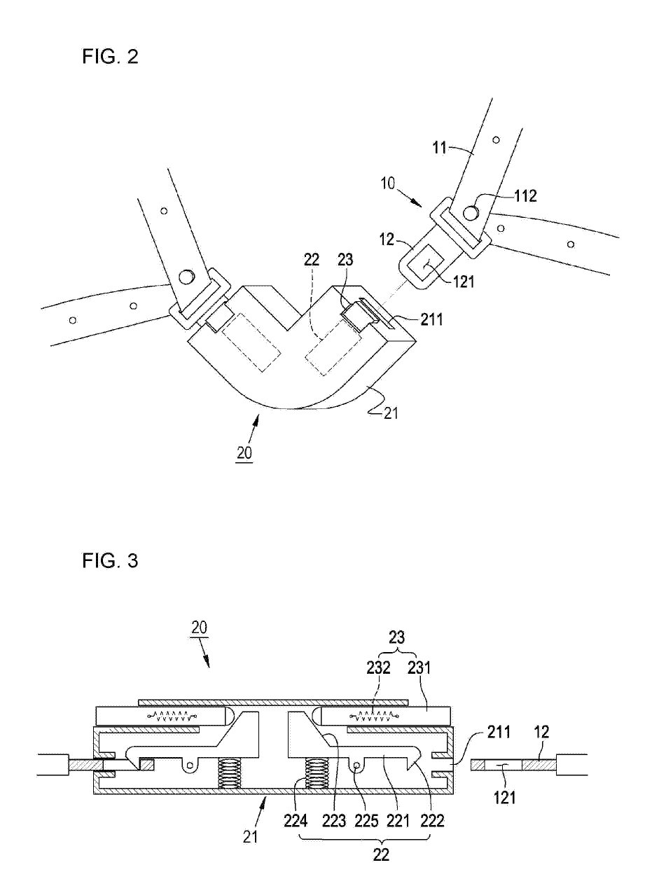

First, a first embodiment will be described with reference to FIG. 1 to FIGS. 4a-4d. The case 21 is formed in the shape of a “V”, and the opening parts 211, into which the fastening clips 12 of the safety belts are inserted, are respectively formed in the both ends of the “V” shape. Of course, since the fastening parts 22 and release parts 23 are provided to the inner space of the case 21, the case 21 must be separated into an upper part and a lower part. Since the case 21 of the fastening device 20 is separated from the safety belts 10 when the fastening device 20 is not fastened to the fastening clips 12, a user carries the fastening device 20 and uses the same only when fastening safety belts in a car.

In order to randomly adjust the height of the fastening device 20, it is possible to fix the position of the fastening clip 12 by affixing a fixing means like a clip and the like to the belt 11, but it is preferable that a plurality of through holes 111 are formed at uniform intervals in the belt 11 and a stopper 112 is inserted into the through hole 111 so as to fix the position of the fastening clip 12 see FIG. 1.

Since the fastening parts 22 are fastened to the fastening clips 12 of the safety belts, which are inserted through the opening parts 211 formed in the case 21, and provided to the inner space of a portion of the case 22, which is inclined in the shape of a “V”, the fastening parts 22 include one pair of the fastening parts 22. In addition, the release parts 23 for releasing the fastening clips 12 of the safety belts, which are fastened to the fastening parts 22, are mounted on the upper end portions of the inner space of the case 21 in a state, in which parts of release buttons 231 are exposed to the outside, so as to release the fastening states of the fastening parts.

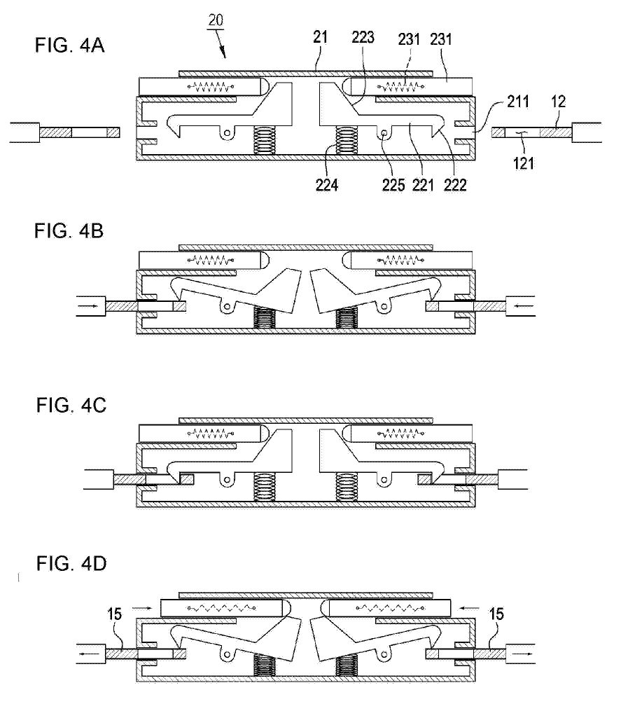

Specifically explaining the fastening part 22 with reference to FIG. 3 and FIGS. 4a-4d, the fastening part 22 is formed in the inner space of the case 21, wherein the front end and the rear end of a fastening member 221 are integrally formed with a holding protrusion 222 and a protrusion portion 223 respectively, which are supported by a first spring 224 and a hinge shaft 225.

The fastening member 221 can carry out seesaw motion with respect to the hinge shaft 225, which is respectively located in the center portions of both sides in the longitudinal direction and coupled to the inside of the case 21. The fastening member 221 has the holding protrusion 222, which is formed on the front end thereof positioned at the opening part 211 side, and the protrusion portion 223, wherein the holding protrusion 222 is protruded vertically in the downward direction and has a front end portion inclined backwards in the downward direction, and the protrusion portion 223 has a rear end portion formed to be protruded in the upward direction and a front surface inclined in the downward direction towards the front end side. In addition, the first spring 224 is formed in a coil spring shape and has both ends, which are respectively mounted between the lower surface of the protrusion portion 223 and the bottom surface of the case 21.

The release part 23 includes the release button 231 and a second spring 232. The release button 231 has a front end, which is positioned at the opening part 211 side, wherein the front end is positioned at the upper portion of the opening part 211 of the case. If the release button 231 is pressed, the rear end of the release button 231 operates to press the inclined surface of the protrusion portion 223. In addition, one pair of second springs are respectively mounted on the both side surfaces of the release button 231, wherein the second spring 232 is mounted such that the both ends thereof are respectively mounted between the side surface of the release button 231 and the inner surface of the upper portion of the inner space of the case 21.

If the fastening clip 12 is pushed and inserted into the opening part 211 of the case 21, the fastening clip 12 slides along the inclined surface formed on the front end of the holding protrusion 222 of the fastening part and the fastening member 221 starts to carry out seesaw motion with respect to the hinge shaft 225 such that the front end portion is lifted and the holding protrusion 222 is inserted into the coupling hole 121 formed in the front end portion of the fastening clip 12, resulting in the coupling and fixing of the fastening device 20 and the fastening clip 12. If the release button 231 is pressed, the rear end of the release button 231 presses the inclined protrusion portion 223 of the fastening part such that the front end portion of the fastening member 221 is lifted and the holding protrusion 222 is separated from the coupling hole 121, resulting in the release of the fastening state between the fastening part 22 and the fastening clip 12 (see FIG. 4).

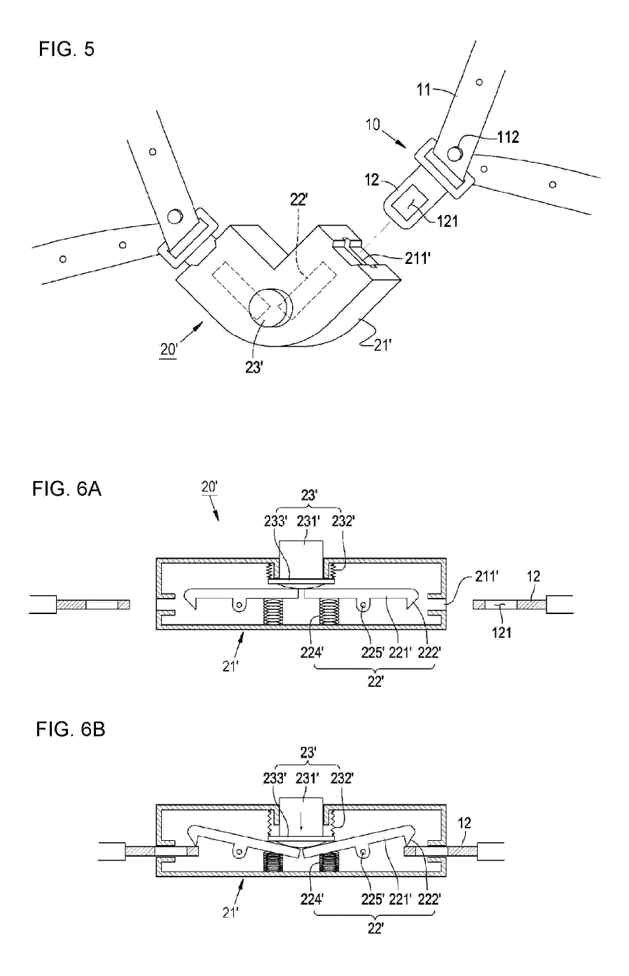

Explaining a second embodiment with reference to FIG. 5 and FIGS. 6a-6b,

The second embodiment differs from the first embodiment in that when releasing the fastening device and the fastening clips, the first embodiment is configured to include a release part for each of the fastening parts so as to release the fastening device from each of the fastening clips respectively, while the second embodiment is configured to release the fastening parts and the fastening clips at both sides by means of a single release button at the same time.

Therefore, the second embodiment will be described only with respect to the configuration different from that of the first embodiment, and the description of the remaining same parts would be redundant and thus omitted.

A fastening member 221′ can carry out seesaw motion with respect to a hinge shaft 225′, which is respectively located in the center portions of both sides in the longitudinal direction and coupled to the inside of a case 21′. The fastening member 221′ has a holding protrusion 222′ formed on the front end thereof, which is positioned at an opening part 211′ side, wherein the holding protrusion 222′ is protruded vertically in the downward direction and has a front end portion inclined backwards in the downward direction. In addition, a first spring 224′ is formed in a coil spring shape and has both ends, which are respectively mounted between the lower surface of the rear end portion of the fastening member 221′ and the bottom surface of the case 21′.

A release part 23′ includes a release button 231′, a pressure plate 233′ and second springs 232′. The release button 231′ has a main body upper end provided to be protruded to the center of the upper portion of the case 21′ and a main body lower end positioned in the inner space of the case 21′. The pressure plate 233′ formed in the shape of a plate with a diameter larger than that of the main body is formed integrally with a main body at the main body lower end, wherein the pressure plate 233′ may be formed in a plate shape and may be formed to be protruded to the outside of the lower end portion of the main body by a predetermined width. In addition, the second springs 232′ are respectively mounted on the both side surfaces of the main body of the release button 231′, wherein the both ends of the second springs 232′ are respectively mounted between the top surface of the pressure plate 233′ and the inner surface of the upper portion of the inner space of the case 21′.

If the upper end of the release button 231′ is pressed, the second springs 232′ are extended and the main body as well as the pressure plate 233′ are lowered such that the pressure plate 233′ presses the rear ends of the fastening members 221′ of one pair of fastening parts 22′, resulting in the release of the fastening states between the respective fastening parts 22′ and the fastening clips 12. Herein, in order to achieve smooth operation, if the pressure plate 233′ is formed in a plate shape, it is preferable that the lower surface of the pressure plate 233′ is formed to be protruded and rounded in the downward direction. In addition, if the pressure plate 233′ is formed to be protruded outwards at the lower end portion of the main body, it is preferable that the lower surface of the main body is formed to be protruded in the downward direction (see FIG. 6).

Meanwhile, even though not shown in the drawings, it is also possible to separately arrange two release parts 23′ in the second embodiment as the first embodiment, wherein, if the release buttons 231′ of the respective release parts 23′ are pressed, the lower surfaces of the release buttons 231′ press the rear ends of the fastening members 221′, thereby releasing the fastening parts 22′ respectively.

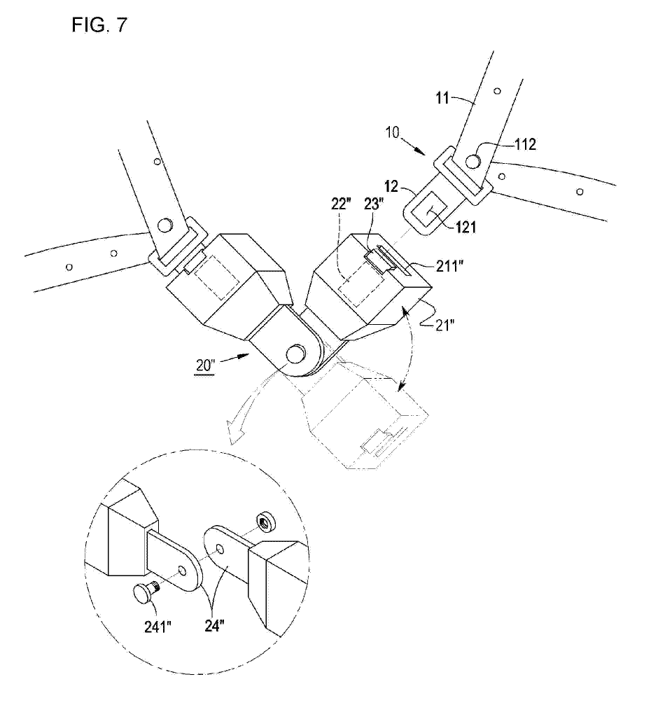

Explaining a third embodiment with reference to FIG. 7, the third embodiment differs from the first embodiment in that the case of the first embodiment is integrally formed in the shape of a “V” while one pair of cases are respectively prepared and then coupled to each other by a connection means in the third embodiment. Therefore, the third embodiment will be described only with respect to the configuration different from that of the first embodiment and, since the remaining parts would be the same as those of the first embodiment, the description thereof would be redundant and thus omitted.

Each of the cases 21″ includes an opening part 211″ formed in the front end thereof, a fastening part 22″, a release part 23″, and a connection plate 24″ provided at the rear end thereof.

The opening part 211″ is formed in the front end of the case 21″ such that the fastening clip 12 of a seat belt is inserted thereinto. The connection plates 24″ for connecting the cases 21″ to each other are mounted on the rear ends of the cases 21″ so as to be protruded.

As for the fastening device 20″ of the third embodiment, the one pair of cases 21″ are arranged so as to form a “V” shape, and parts of the end portions of the connection plates 24″, which are protruded from the rear ends of the respective cases 21″, are overlapped with each other and then connected to each other by a connection means 241″ such as a bolt and a nut, thereby being integrated.

Since the foregoing description is illustrative of the present invention and the embodiments disclosed in the specification are intended to illustrate rather than limit the technical idea of the present invention, it will be apparent to those skilled in the art that various changes and modifications may be made without departing from the technical idea of the present invention. Therefore, the protective scope of the present invention should be construed as being defined by the features set forth in the following claims, and technical features within the equivalent scope thereto should also be construed as belonging to the technical scope of the present invention.

What is claimed is:

1. A portable fastening device for a safety belt of a car, for fastening safety belts respectively positioned at both sides of a seat in a car, the portable fastening device for a safety belt of a car, comprising:
a case formed in the shape of a “V” and having opening parts formed to be separate from each other in both ends of the “V”-shaped case such that the fastening clips of seat belts, which are respectively positioned at both sides of a seat, are inserted thereinto;
one pair of fastening parts respectively provided to the inner space of a portion, which is inclined in the shape of “V” in the case, so as to be fastened to the fastening clips of the safety belts, which are inserted through the opening parts; and
release parts mounted on upper end portions of the inner space of the case so as to operate such that the fastening clips of the safety belts, which are fastened to the fastening parts, are released,
wherein the portable fastening device for a safety belt of a car is to be carried and fastened to each of the fastening clips of the safety belts respectively positioned at both sides of a seat in a car.

2. The portable fastening device for a safety belt of a car, according to claim 1, wherein
each of the fastening parts of the one pair of fastening parts, includes:
a fastening member capable of carrying out seesaw motion with respect to a hinge shaft, which is respectively located in the center portions of both sides in the longitudinal direction, and having a holding protrusion, which is formed on the front end thereof so as to be protruded vertically in the downward direction, and a protrusion portion, of which a rear end portion is formed to be protruded in the upward direction and a front surface is inclined in the downward direction towards the front end side; and
a first spring, of which both ends are respectively mounted between the lower surface of the protrusion portion of the fastening member and the bottom surface of the case, and
the release parts include one pair of release parts corresponding to the fastening parts, and each of the release parts includes:
a release button, of which a front end is positioned at the upper portion of the opening part of the case and a rear end operates to press the inclined portion of the protrusion portion; and
one pair of second springs, of which both ends are respectively mounted between the side surface of the release button and the inner surface of the upper portion of the inner space of the case,
wherein the fastening states of the fastening parts and the fastening clips are respectively released by pressing the release buttons of the release parts respectively.

3. The portable fastening device for a safety belt of a car, according to claim 1, wherein
each of the fastening parts of the one pair of fastening parts, includes:
a fastening member capable of carrying out seesaw motion with respect to a hinge shaft, which is respectively located in the center portions of both sides in the longitudinal direction, and having a holding protrusion, which is formed on the front end thereof so as to be protruded vertically in the downward direction; and
a first spring, of which both ends are respectively mounted between the lower surface of the rear end portion of the fastening member and the bottom surface of the case, and
the release part includes:
a release button, of which a main body upper end is provided to be protruded to the center of the upper portion of the case and a main body lower end positioned in the inner space of the case has a pressure plate, which is formed integrally with a main body thereof and has a diameter larger than that of the main body; and
one pair of second springs, of which both ends are respectively mounted between the top surface of the pressure plate of the release button and the inner surface of the upper portion of the inner space of the case so as to be provided outside the main body of the release button,
wherein, if the release button is pressed, the pressure plate presses the rear ends of the fastening members of the one pair of fastening parts simultaneously such that the respective fastening states of the fastening parts and the fastening clips are simultaneously released.

4. The portable fastening device for a safety belt of a car, according to claim 1, wherein
each of the fastening parts of the one pair of fastening parts, includes:
a fastening member capable of carrying out seesaw motion with respect to a hinge shaft, which is respectively located in the center portions of both sides in the longitudinal direction, and having a holding protrusion, which is formed on the front end thereof so as to be protruded vertically in the downward direction; and
a first spring, of which both ends are respectively mounted between the rear end portion of the fastening member and the bottom surface of the case, and
the release parts include one pair of release parts corresponding to the fastening parts, and each of the release parts includes:
a release button, of which a main body upper end is provided to be protruded to the center of the upper portion of the case and a main body lower end positioned in the inner space of the case has a pressure plate, which is formed integrally with a main body thereof and has a diameter larger than that of the main body; and
one pair of second springs, of which both ends are respectively mounted between the top surface of the pressure plate of the release button and the inner surface of the upper portion of the inner space of the case so as to be provided outside the main body of the release button,
wherein, if the release buttons of the respective release parts are pressed, the pressure plates press the rear ends of the fastening members of the respective fastening parts such that the fastening states of the fastening parts and the fastening clips are released.

5. A portable fastening device for a safety belt of a car, for fastening safety belts respectively positioned at both sides of a seat in a car, the portable fastening device for a safety belt of a car, comprising:
one pair of cases having opening parts, which are formed in the front ends thereof such that the fastening clips of seat belts are inserted thereinto, and connection plates, which are formed to be protruded at the rear ends thereof;
fastening parts respectively provided to the inner space of the cases, so as to be fastened to the fastening clips of the safety belts, which are inserted through the opening parts;
release parts mounted on upper end portions of the inner spaces of the respective cases so as to operate such that the fastening clips of the safety belts, which are fastened to the fastening parts, are released; and
connection plates formed to be protruded from the rear ends of the respective cases,
wherein one pair of cases are arranged to form a “V” shape such that the end portions of the respective connection plates are partially overlapped with each other so as to be connected to each other by a connection means, and the portable fastening device for a safety belt of a car is to be carried and fastened to each of the fastening clips of the safety belts respectively positioned at both sides of a seat in a car.

6. The portable fastening device for a safety belt of a car, according to claim 5, wherein
the fastening part includes:
a fastening member capable of carrying out seesaw motion with respect to a hinge shaft, which is respectively located in the center portions of both sides in the longitudinal direction, and having a holding protrusion, which is formed on the front end thereof so as to be protruded vertically in the downward direction, and a protrusion portion, of which a rear end portion is formed to be protruded in the upward direction and a front surface is inclined in the downward direction towards the front end side; and
a first spring, of which both ends are respectively mounted between the lower surface of the protrusion portion of the fastening member and the bottom surface of the case, and
the release parts include:
release buttons, of which front ends are positioned at the upper portions of the opening parts of the cases and rear ends operate to press the inclined protrusion portions of the fastening members; and
one pair of second springs, of which both ends are respectively mounted between the side surfaces of the release buttons and the inner surfaces of the upper portions of the inner spaces of the cases,
wherein the fastening states of the fastening parts and the fastening clips are respectively released by pressing the release buttons of the release parts respectively.
